(19) United States
(12) Patent Application Publication
(10) Pub. No.: US 2026/0222280 A1
(43) Pub. Date: Jul. 30, 2026

(54) LOCALIZATION OF DISTURBANCE IN A NETWORK COMPOSED OF WIRELESS LINKS

(71) Applicant: Telefonaktiebolaget LM Ericsson (publ), Stockholm (SE)

(72) Inventors: Martin Sjödin, Göteborg (SE); Anders Kvist, Kullavik (SE); Paolo Debenedetti, Albissola Marina (SV) (IT); Marcello Morchio, Genova (IT); Annamaria Fulignoli, Pisa (IT)

(21) Appl. No.: 19/150,291

(22) PCT Filed: Feb. 20, 2023
(86) PCT No.: PCT/EP2023/054137

§ 371 Date: Jul. 23, 2025

(51) Int. Cl. H04L 41/0677; H04W 24/08

(52) U.S. Cl. CPC H04L 41/0677; H04W 24/08

(57) ABSTRACT

Techniques for localizing disturbance in a network comprises wireless links that extend between pairs of end-points. A method comprises comparing time-series sequences for pairs of the wireless links with each other. The method comprises identifying, based on the compared time-series sequences, that performance of one pair of the wireless links is impaired by a disturbance caused at the end-point that is common for both the wireless links of the one of the pairs of the wireless links. The method comprises localizing which component at the common end-point that is responsible for causing the disturbance by comparing the site data of the common end-point for the wireless links of the one of the pairs of the wireless links to each other.

### TECHNICAL FIELD

Embodiments presented herein relate to a method, a controller entity, a computer program, and a computer program product for localizing disturbance in a network.

### BACKGROUND

In a wireless communication system, digital information is sent over point-to-point wireless links between two nodes. These two nodes can typically be spaced from a few hundred meters up to several kilometers. Each node comprises link equipment, such as an antenna, a radio for frequency up- and down-conversion, and a modem for digital signal processing, used for transmission and reception of wireless signals over the point-to-point wireless links.

Point-to-point wireless links are sometimes subjected to disturbances. Wireless link performances may be impacted by several factors, such as weather conditions as well as the alignment between the two endpoints of a wireless link, or an obstacle being placed (either temporarily or permanently) between the endpoints of the wireless link. As one non-limiting example, when the antennas in the endpoints get misaligned, the received signal power is reduced. As another non-limiting example, in case of rotation of the antennas, the polarization might also be affected. Such disturbances affect the received signal power and quality. This might trigger alarms that are sent to the network operator. When a network operator suspects that the link equipment is not working properly, a common response is to make a site visit (i.e., to send maintenance personnel to inspect the link equipment). Such a site visit sometimes results in the link equipment, or at least part thereof, being shipped back to the manufacturer for maintenance, or even replacement.

It has been found during inspections that a significant fraction of the link equipment sent back to the manufacturer in fact does not suffer from impaired operation and no faults are found. This indicates that resources, such as time and money, might be saved if network operators are provided with more accurate feedback about their network equipment.

Some disturbances may be due to site conditions (e.g., tower swaying) or external factors, such as local environmental issues (e.g., local obstacles) and not relevant to a specific end-point. In this respect, measurements made on the wireless link and its neighbors can be elaborated via artificial intelligence (AI) or machine learning (ML) processing in order to classify in advance the probable cause for any faulty or degraded link, such as weather conditions and/or antenna swaying impacting the link performance.

EP 3868026 A1 relates to distinguishing between, and/or identifying, different disturbance events which affect the communication in a point-to-point radio link arrangement.

However, even if the probable cause for any faulty or degraded link can be classified, it can still be difficult to localize the disturbance.

### SUMMARY

An object of embodiments herein is to address the above issues and shortcomings of existing technology.

According to a first aspect there is presented a controller entity for localizing disturbance in a network comprises wireless links that extend between pairs of end-points. Each of the end-points is composed of components. Each of the wireless links is associated with site data defining an abstracted representation of the components per end-point per wireless link. The controller entity comprises processing circuitry. The processing circuitry is configured to cause the controller entity to compare time-series sequences for pairs of the wireless links with each other. Each of time-series sequences is composed of link attenuation values for one of the wireless links. The pairs of wireless links for which the time-series sequences are compared to each other have one of the end-points in common. The processing circuitry is configured to cause the controller entity to identify, based on the compared time-series sequences, that performance of one of the pairs of the wireless links is impaired by a disturbance caused at the end-point that is common for both the wireless links of said one of the pairs of the wireless links. The processing circuitry is configured to cause the controller entity to localize which component at the common end-point that is responsible for causing the disturbance by comparing the site data of the common end-point for the wireless links of said one of the pairs of the wireless links to each other.

According to a second aspect there is presented a controller entity for localizing disturbance in a network comprises wireless links that extend between pairs of end-points. Each of the end-points is composed of components. Each of the wireless links is associated with site data defining an abstracted representation of the components per end-point per wireless link. The controller entity comprises a compare module configured to compare time-series sequences for pairs of the wireless links with each other. Each of time-series sequences is composed of link attenuation values for one of the wireless links. The pairs of wireless links for which the time-series sequences are compared to each other have one of the end-points in common. The controller entity comprises an identify module configured to identify, based on the compared time-series sequences, that performance of one of the pairs of the wireless links is impaired by a disturbance caused at the end-point that is common for both the wireless links of said one of the pairs of the wireless links. The controller entity comprises a localize module configured to localize which component at the common end-point that is responsible for causing the disturbance by comparing the site data of the common end-point for the wireless links of said one of the pairs of the wireless links to each other.

According to a third aspect there is presented a method for localizing disturbance in a network comprises wireless links that extend between pairs of end-points. Each of the end-points is composed of components. Each of the wireless links is associated with site data defining an abstracted representation of the components per end-point per wireless link. The method is performed by a controller entity. The method comprises comparing time-series sequences for pairs of the wireless links with each other. Each of time-series sequences is composed of link attenuation values for one of the wireless links. The pairs of wireless links for which the time-series sequences are compared to each other have one of the end-points in common. The method comprises identifying, based on the compared time-series sequences, that performance of one of the pairs of the wireless links is impaired by a disturbance caused at the end-point that is common for both the wireless links of said one of the pairs of the wireless links. The method comprises localizing which component at the common end-point that is responsible for causing the disturbance by comparing the site data of the common end-point for the wireless links of said one of the pairs of the wireless links to each other.

According to a fourth aspect there is presented a computer program for localizing disturbance in a network. The computer program comprises computer code which, when run on processing circuitry of a controller entity, causes the controller entity to perform actions. One action comprises the controller entity to compare time-series sequences for pairs of the wireless links with each other. Each of time-series sequences is composed of link attenuation values for one of the wireless links. The pairs of wireless links for which the time-series sequences are compared to each other have one of the end-points in common. One action comprises the controller entity to identify, based on the compared time-series sequences, that performance of one of the pairs of the wireless links is impaired by a disturbance caused at the end-point that is common for both the wireless links of said one of the pairs of the wireless links. One action comprises the controller entity to localize which component at the common end-point that is responsible for causing the disturbance by comparing the site data of the common end-point for the wireless links of said one of the pairs of the wireless links to each other.

According to a fifth aspect there is presented a computer program product comprising a computer program according to the fourth aspect and a computer readable storage medium on which the computer program is stored. The computer readable storage medium could be a non-transitory computer readable storage medium.

Advantageously, these aspects provide efficient localization of which component at the common end-point that is responsible for causing any identified disturbance.

Advantageously, these aspects enable localization and classification of the component causing the disturbance event (e.g., mechanical, environmental, geological) in order to define any necessary action for mitigating the disturbance event as well as to adopt preventive action to avoid future disturbance events.

Advantageously, by being able to identify at which end-point of a wireless link a disturbance event occurs, the number of potential site visits will be reduced from 2 to 1.

Advantageously, the link attenuation values for the wireless links are readily available from the transceivers of the wireless links and hence neither dedicated measurements need to be obtained nor dedicated sensors need to be used in order for the time-series sequences to be obtained.

Advantageously, these aspects enable potential future disturbance events at the end-points to be predicted. In turn, this enables preventive actions to be performed before such future disturbance events actually occur.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a network according to embodiments;

FIG. 2 schematically illustrates a system according to embodiments;

FIG. 3 is a flowchart of methods according to embodiments;

FIG. 4 schematically illustrates a first example of end-points placed at different sites according to an embodiment;

FIG. 5 schematically illustrates a second example of end-points placed at different sites according to an embodiment;

FIG. 6 schematically illustrates time-domain processing of time-series sequences according to embodiments;

FIG. 7 schematically illustrates frequency-domain processing of time-series sequences according to embodiments;

FIG. 8 schematically illustrates frequency components of time-series sequences according to embodiments;

FIG. 9 schematically illustrates input data set construction using spectrum aggregation according to embodiments;

FIG. 10 schematically illustrates input data set construction using the frequency components with highest magnitude according to embodiments;

FIG. 11 schematically illustrates processing of time-series sequences from multiple wireless links according to embodiments;

FIG. 12 is a schematic diagram showing functional units of a controller entity according to an embodiment;

FIG. 13 is a schematic diagram showing functional modules of a controller entity according to an embodiment; and

FIG. 14 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

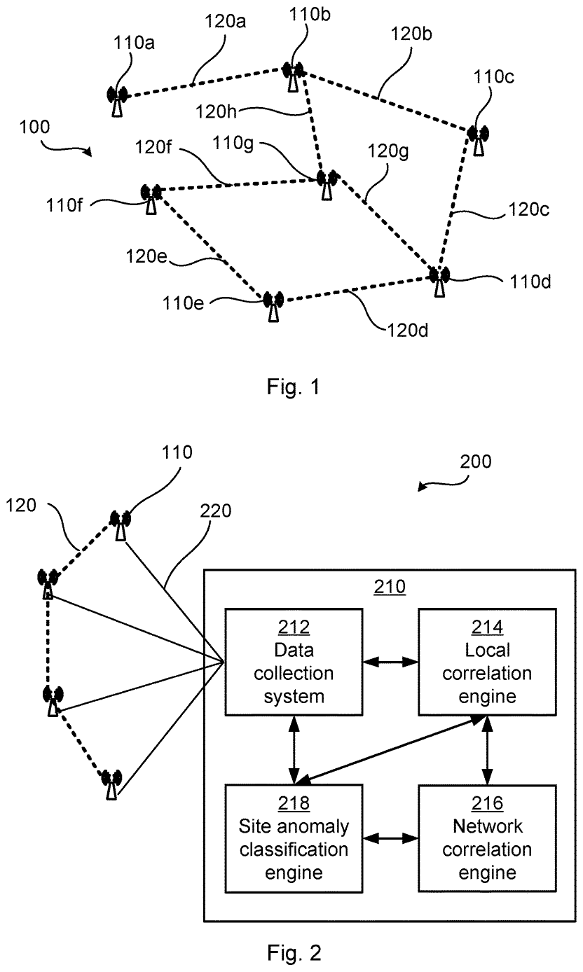

FIG. 1 is a schematic diagram illustrating a network 100 where embodiments presented herein can be applied. The network 100 comprises point-to-point wireless links 120a: 120h (eight in total) extending between endpoints 110a: 110g (seven in total). Each of the endpoints 110a: 110g can be a microwave transceiver.

In FIG. 2 is illustrated a system 200 comprising some of the end-points 110 of FIG. 1 (with wireless links 120 extending between the end-points 110). The end-points are configured to provide data in terms of time-series sequences composed of link attenuation values to a controller entity 210 over (backhaul) links 220. The controller entity 210 comprises a data collecting system 212, a local correlation engine 214, a network correlation engine 216 and a site anomaly classification engine 218.

The data collecting system 212 is configured to retrieve data provided by the end-points 110. The data is provided to the local correlation engine 214 and to the site anomaly classification engine 218.

The local correlation engine 214 is configured to compute local inferences, in terms of vectors of timestamped link disturbance events, in the network 100. The input to the local correlation engine 214 is the data as retrieved by the data collecting system 212 from the end-points 110. The output vectors describe the probability of the possible link disturbance events within a given time window. The local correlation engine 214 might thereby identify link disturbance events limited to the scope of each individual wireless link. Further, the local correlation engine 214 can also report long-term link disturbance events that can be seamlessly combined by the network correlation engine 216 to classify network disturbance events, such as landslides or tower displacements.

The network correlation engine 216 is configured to compute network-level inferences in the network 100. The inputs to the network correlation engine 216 are the vectors of timestamped link disturbance events generated by the local correlation engine 214 and position indicating information of the end-points 110. In some examples the network correlation engine 216 takes advantage of the link classification built by the local correlation engine 214, combined with additional information on the network topology and the end-point locations. The output from the network correlation engine 216 is a classification, which can classify the status of the network 100, or a subnetwork, on a time granularity based on the history of the network 100 within a given time interval. In particular, the network correlation engine 216 is configured to classify the probable cause of the network disturbance event. The output of the network correlation engine 216 is provided to the site anomaly classification engine 218.

Once the network correlation engine 216 has excluded network-wide disturbance events, the site anomaly classification engine 218 identifies end-points 110;110a: 110g where a disturbance event occurs and the type of disturbance event to properly instruct on-site maintenance personnel to resolve the disturbance event or adopt preventive maintenance actions. The site anomaly classification engine 218 is configured to collect high-rate sampled time-series sequences composed of link attenuation values from the data collecting system 212 as well as correlate the classifications obtained by the local correlation engine 214 and the network correlation engine 216. The high-rate sampled time-series sequences might be obtained for a limited network portion identified by the network correlation engine 216. As will be further disclosed below, the site anomaly classification engine 218 might be configured to operate directly on the time-series sequences in the time domain, or upon the time-series sequences having been transformed to the frequency domain, and/or applying artificial intelligence and/or machine learning techniques to localize which component at the common end-point 110;110a: 110g that is responsible for causing the disturbance.

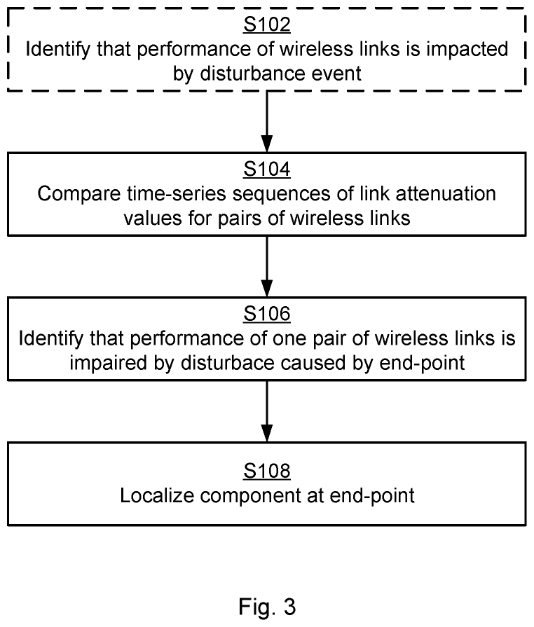

FIG. 3 is a flowchart illustrating embodiments of methods for localizing disturbance in a network 100. The network 100 comprises wireless links 120;120a: 120h that extend between pairs of end-points 110;110a: 110g. Each of the end-points 110;110a: 110g is composed of components. Each of the wireless links 120;120a: 120h is associated with site data defining an abstracted representation of the components per end-point 110;110a: 110g per wireless link 120;120a: 120h. The methods are performed by the controller entity 210, 1200, 1300. The methods are advantageously provided as computer programs 1420.

S104: The controller entity 210, 1200, 1300 compares time-series sequences for pairs of the wireless links 120;120a: 120h with each other. Each of time-series sequences is composed of link attenuation values for one of the wireless links 120;120a: 120h. The pairs of wireless links 120;120a: 120h for which the time-series sequences are compared to each other have one of the end-points 110;110a: 110g in common.

S106: The controller entity 210, 1200, 1300 identifies, based on the compared time-series sequences, that performance of one of the pairs of the wireless links 120;120a: 120h is impaired by a disturbance caused at the end-point 110;110a: 110g that is common for both the wireless links 120;120a: 120h of this one of the pairs of the wireless links 120;120a: 120h. In some examples, the identifying in S106 is based on confirming that the comparison of the time-series sequences for this one of the pairs of the wireless links 120;120a: 120h satisfies at least one correlation criterion.

S108: The controller entity 210, 1200, 1300 localizes which component at the common end-point 110;110a: 110g that is responsible for causing the disturbance by comparing the site data of the common end-point 110;110a: 110g for the wireless links 120;120a: 120h of this one of the pairs of the wireless links 120;120a: 120h to each other.

Advantageously, this method provides efficient localization of which component at the common end-point that is responsible for causing any identified disturbance.

Advantageously, this method enables localization and classification of the component causing the disturbance event (e.g., mechanical, environmental, geological) in order to define any necessary action for mitigating the disturbance event as well as to adopt preventive action to avoid future disturbance events.

Advantageously, by being able to identify at which end-point of a wireless link a disturbance event occurs, the number of potential site visits will be reduced from 2 to 1.

Advantageously, the link attenuation values for the wireless links are readily available from the transceivers of the wireless links and hence neither dedicated measurements need to be obtained nor dedicated sensors need to be used in order for the time-series sequences to be obtained.

Advantageously, this method enables potential future disturbance events at the end-points to be predicted. In turn, this enables preventive actions to be performed before such future disturbance events actually occur.

As follows from the above, the method is applicable to wireless links 120;120a: 120h having at least one neighboring wireless links 120;120a: 120h with end-point 110;110a: 110g at the same geographical location and mounted on the same structure (e.g., mast, tower, etc.).

Embodiments relating to further details of localizing disturbance in a network 100 as performed by the controller entity 210, 1200, 1300 will now be disclosed with continued reference to FIG. 3.

There may be different types of wireless links 120;120a: 120h. In some examples, the wireless links 120;120a: 120h are wireless microwave links, and the disturbance relates to variations of received power and/or attenuation on either side of the wireless microwave links. In other examples, the wireless links 120;120a: 120h are free space optical links, and the disturbance relates to variations of received power on either side of the free space optical links. In yet other examples, the wireless links 120;120a: 120h are Terahertz (THz) links.

In some aspects, the controller entity 210, 1200, 1300 identifies that the link performance is impacted by a disturbance event. This identification can be based on classification of the time-series sequences. That is, in some embodiments, the controller entity 210, 1200, 1300 is configured to perform (optional) step S102.

S102: The controller entity 210, 1200, 1300 identifies, by classifying the time-series sequences, that the performance of the wireless links 120;120a: 120h of one of the pairs of the wireless links 120;120a: 120h is impacted by a disturbance event.

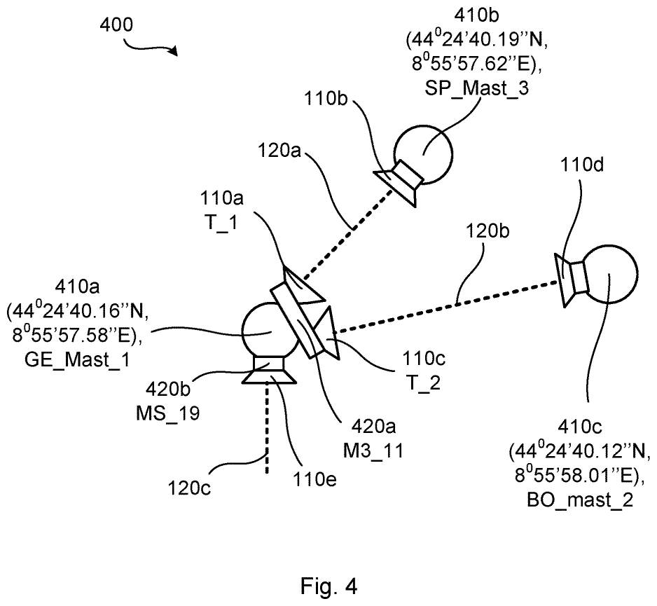

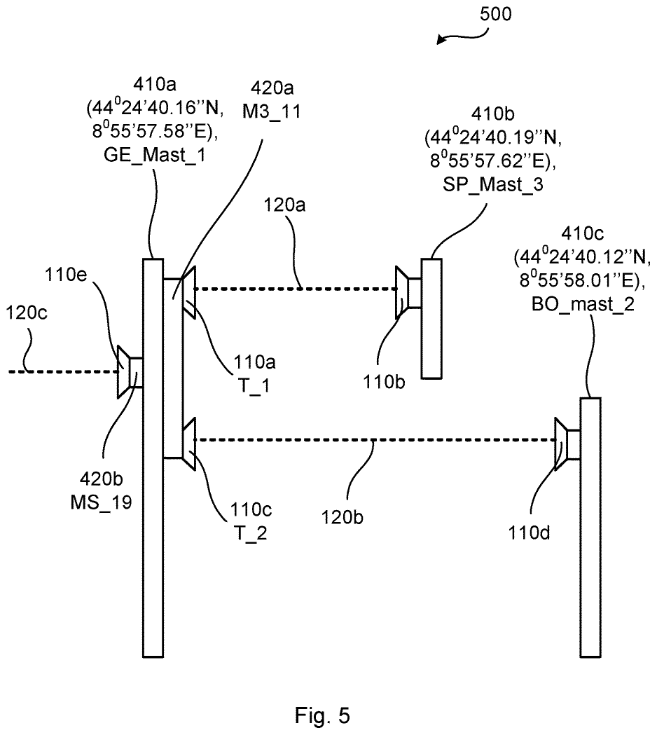

Aspects of the site data will be disclosed next with reference to FIG. 4 and FIG. 5.

As disclosed above, the site data defines an abstracted representation of the components per end-point 110;110a: 110g per wireless link 120;120a: 120h. The site data is thus composed of logistics information about components of the sites at which the end-points are installed. The site data for each end-point can be configured locally by installation personnel without any knowledge of the overall network structure; only information that can be acquired locally from the site is needed.

In some examples, the site data is represented by sets of labels associated with each end-point. The site data can therefore be used to trace components of the end-points in a hierarchical manner. That is, in some embodiments, the site data for each of the end-points 110;110a: 110g is provided as hierarchically-structured labels, extending from a root label to one or more leaf labels. Each of the labels per end-point 110;110a: 110g represents one of the components of said one of the end-points 110;110a: 110g.

There can be different examples of site data. In some embodiments, the root label for each of the end-points 110;110a: 110g is defined by a geo-location of the end-point 110;110a: 110g. The one or more leaf labels per end-point 110;110a: 110g represents one or more of the components of one of the end-points 110;110a: 110g, such as a support structure, a mechanical structure, and/or an antenna of the end-point 110;110a: 110g.

In FIG. 4 is provided an illustration of a system 400 composed of five different end-points 110a: 110e, placed at three different sites 410a, 410b, 410c. In FIG. 5 is provided an illustration of a system 500 composed of the same five different end-points as in FIG. 4. FIG. 4 is a top view whereas FIG. 5 is a side view. The sites are placed at geo-locations with coordinates (44°24′40.19″N, 8°55′57.62″E), (44°24′40.16″N, 8°55′57.58″E), and (44°24′40.12″N, 8°55′58.01″E). Each end-point is associated with its own set of site data. Three of the end-points thus share the same geo-location and hence the same site data label: 44°24′40.16″N, 8°55′57.58″E. These three end-points 110a, 110c, 110e are located at a site 410a with site data label: GE_Mast_1. The end-point 110b at the geo-location with coordinates (44°24′40.19″N, 8°55′57.62″E) is located at a site 410b with site data label: SP_Mast_3. The end-point 110d at the geo-location with coordinates (44°24′40.12″N, 8°55′58.01″E) is located at a site 410c with site data label: BO_Mast_2. Further, two of the end-points 110a, 110c at the site 410a with site data label: GE_Mast_1 share the same mast 420a, with site data label: M3_11, but have different transceivers; T_1 and T_2, respectively. The third end-point 110e at the site 410a with site data label: GE_Mast_1 is located at a mast 420b with site data label: M5_19. One wireless link 120a extends between the end-point with site data [44°24′40.16″N, 8°55′57.58″E, GE_Mast_1, M3_11, T_1] and the end-point with site data [44°24′40.19″N, 8°55′57.62″E, SP_Mast_3]. Another wireless link 120b extends between the end-point with site data [44°24′40.16″N, 8°55′57.58″E, GE_Mast_1, M3_11, T_2] and the end-point with site data [44°24′40.12″N, 8°55′58.01″E, BO_Mast_2]. Hence, this pair of wireless links share one common end-point, up to (but not including) the transceiver (T_1 for one of the wireless links 120a and T_2 for the other wireless link 120b). As an illustrative example, it is assumed that it is determined that there is disturbance event associated with this pair of wireless links. From this it can be concluded that the disturbance event is associated with the common end-point. Site data for the different wireless links is then compared for end-point A in order to identify what site data these wireless links have in common. As noted above, the site data is identical down to, but not including, which transceiver is used. It can therefore be concluded that the disturbance is caused by a component at the mast M3_11. It is here noted that this conclusion depends on whether there is also a disturbance event for the third link on the site, in which case the common component would be GE_Mast_1.

Which component at the common end-point 110;110a: 110g that is responsible for causing the disturbance can be determined based on analysis of the time-series sequences in the time domain, in the frequency domain, and/or applying artificial intelligence and/or machine learning techniques.

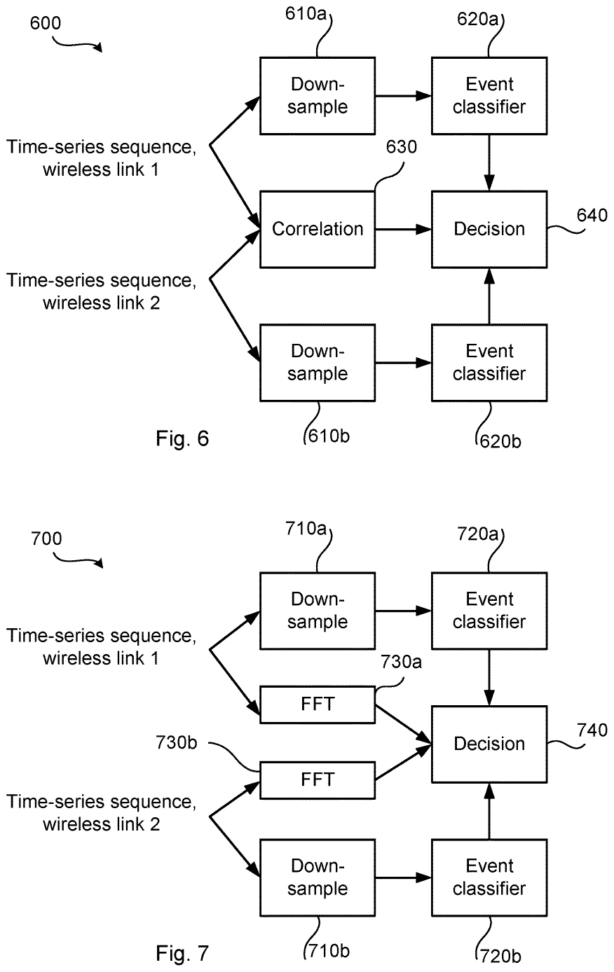

Aspects of localizing which component at the common end-point 110;110a: 110g that is responsible for causing the disturbance based on analysis of the time-series sequences in the time domain will be disclosed next with reference to the block diagram 600 of FIG. 6.

In some embodiments, the comparing of the time-series sequences for each pair of wireless links 120;120a: 120h is performed as a time-domain correlation between the time-series sequences for each pair of wireless links 120;120a: 120h upon the time-series sequences for each pair of wireless links 120;120a: 120h having been time-synchronized with each other.

As illustrated in FIG. 6, time-series sequences of two wireless links are provided to event classifiers 620a, 620b. The event classifiers are configured to identify disturbance events (e.g., wind) by analyzing each of the time-series sequences. For this purpose, the event classifiers could be implemented by the local correlation engine 214. But also another algorithm that satisfies the objective can be used. This identification can be carried out by analyzing time-series sequences at a low sampling rate. Hence, the event classifiers might be preceded by down-sampling blocks 610a, 610b. Therefore, in some embodiments, a higher sample rate of the time-series sequences is used when comparing the time-series sequences than when classifying the time-series sequences.

Further, a correlation block 630 is configured to correlate the time-series sequences of the two wireless links. In particular, in some embodiments, identifying that performance of one of the pairs of the wireless links 120;120a: 120h is impaired by the disturbance caused at the end-point 110;110a: 110g that is common for both wireless links 120;120a: 120h of one of the pairs of the wireless links 120;120a: 120h comprises verifying that the time-domain correlation satisfies the at least one correlation criterion. This correlation can be carried out for time-series sequences with high sampling rate to capture rapid fluctuations due to, e.g., wind or vibrations. The time-series sequences might be normalized before correlation such that the result of the correlation is agnostic with respect to the absolute values of the link attenuation. In some examples the normalization involves to, for each time-series sequence, subtract the mean attenuation value from all samples, and divide the time-series sequence with the largest absolute signal value. The correlation between two time-series sequences can then be defined as their scalar product divided by the number of samples.

The information of any identified disturbance events as provided by the event classifiers and the result of the correlation as provided by the correlation block are provided as input to a decision block 640. The logics of the decision block is based on the following. If both classification results (i.e., for both of the time-series sequences that are compared) are the same (as an example indicating wind) and the correlation measure exceeds a given threshold, it can be assumed that the wind problem is due to issues at the common end-point. On the other hand, if the classification results indicate wind but the correlation is close to zero, this indicates that there likely are issues at the other end-points of the wireless links. In this respect, two time-series sequences can be considered highly correlated if their correlation is higher than some threshold value.

Aspects of localizing which component at the common end-point 110;110a: 110g that is responsible for causing the disturbance based on analysis of the time-series sequences in the frequency domain will be disclosed next with reference to the block diagram 700 of FIG. 7.

Frequency domain processing can simplify the comparison of the time-series sequences compared to the use of correlation as in the time domain approach disclosed above with reference to FIG. 6. Frequency domain processing does not require that the time-series sequences that are compared are time-wise synchronized between each other. This is since it is sufficient to compare the magnitude of the frequency components. One reason for this is that it is unlikely that swaying or shaking on the other end-points of the involved wireless links would occur at the same frequencies as the swaying/shaking at the common end-points. Synchronization in the time domain can be achieved by comparing timestamps for the two time-series sequences (e.g. from the start of the data collection) with each other and performing a phase rotation on the frequency components from one of the wireless link to correct for any time offsets between the two time-series sequences.

The operations of the event classifiers remain the same as for the processing in the time domain. That is, the time-series sequences of two wireless links are provided to event classifiers 720a, 720b that could be implemented by the local correlation engine 214. But also another algorithm that satisfies the objective can be used. The identification can be carried out by analyzing time-series sequences at a low sampling rate. Hence, the event classifiers might be preceded by down-sampling blocks 710a, 710b.

In some embodiments, the comparing of the time-series sequences for each pair of wireless links 120;120a: 120h is performed as a frequency-domain comparison between the time-series sequences for each pair of wireless links 120;120a: 120h upon the time-series sequences for each pair of wireless links 120;120a: 120h having been transformed to frequency domain. In FIG. 7 the transformation of the time-series sequences to the frequency domain is represented by FFT blocks, 730a, 730b where FFT is short for Fast Fourier Transform and is used to practically perform a DFT (Discrete Fourier Transform). Therefore, the granularity of frequency components is defined by the algorithm used for the FFT. The spectrum can be represented as a one-dimensional vector of energy contributions. Each of the time-series sequences for each pair of wireless links 120;120a: 120h, when having been transformed to the frequency domain, is composed of frequency components. The comparing of the time-series sequences in the decision block 740 then comprises comparing the frequency components of different wireless links 120;120a: 120h of the pair of wireless links 120;120a: 120h with each other, and using the output of the event classifiers.

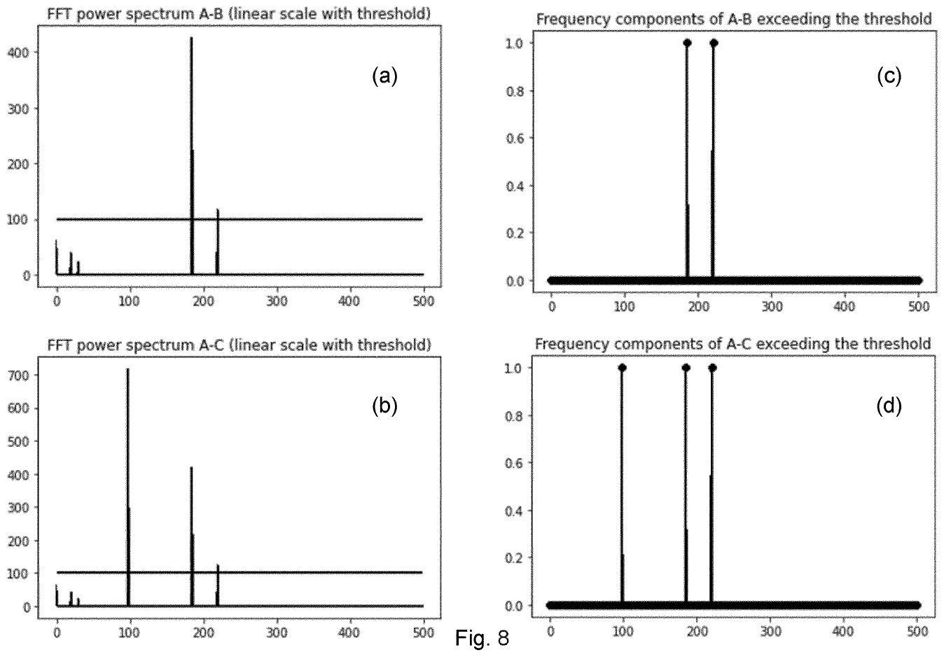

It can be assumed that if disturbance events such as mast sway or mast problems originate at the same site then the time-series sequences of both wireless links will exhibit swaying/shaking at the same frequency or within the same frequency range. That this is the case can be assessed by converting the time-series sequences for each pair of wireless links 120;120a: 120h to the frequency domain and then analyzing how the energy of the attenuation signals is distributed in the frequency domain. In particular, in some embodiments, identifying that performance of one of the pairs of the wireless links 120;120a: 120h is impaired by the disturbance caused at the end-point 110;110a: 110g that is common for both wireless links 120;120a: 120h of one of the pairs of the wireless links 120;120a: 120h comprises verifying that at least one of the frequency components of different wireless links 120;120a: 120h of the pair of wireless links 120;120a: 120h satisfies the at least one correlation criterion. For example, all components (i.e., the frequencies) whose magnitudes exceeds a given threshold, representing an amplitude of attenuation variation, can be compared. This is illustrated in FIG. 8 which illustrates that the frequency components (a) of a first wireless link and the frequency components (b) of a second wireless link are compared to a threshold. For the first wireless link there are two frequency components that exceed the threshold. For the second wireless link there are three frequency components that exceed the threshold. Further, the frequency components (c) of the first wireless link that exceed the threshold are compared to the frequency components (d) of the second wireless link that also exceed the same threshold. As can be seen in FIG. 8, both of the frequency components that exceed the threshold for the first wireless link overlap with two of the frequency components that exceed the threshold for the second wireless link.

If both classification results (i.e., for both of the time-series sequences that are compared) are the same (as an example indicating wind) and the sway for both wireless links occur at the same frequencies, it can be assumed that the wind problem is due to issues at the common end-point, On the other hand, if the classification results indicate wind but the frequency components do not match, this indicates that there likely are issues at the other end-points of the wireless links. It could also be so that pairs of wireless links suffer from one disturbance event due to issues at the common end-point, but that one (or both) of the wireless links suffer from individual disturbance events that may be due to the other end-point for the wireless link in question, or a disturbance event at the common end-point that only affects one of the wireless links. This is illustrated in FIG. 8 by the third frequency components of the second wireless link that exceeds the threshold but where there is not any corresponding frequency component for the first wireless link.

Aspects of localizing which component at the common end-point 110;110a: 110g that is responsible for causing the disturbance based on using artificial intelligence and/or machine learning based analysis of the time-series sequences will be disclosed next.

In some embodiments, the comparing, the identifying, and the localizing are performed by a supervised machine learning model. The supervised machine learning model is fed an input data set. The input data set at least comprises the time-series sequences for each of the wireless links 120;120a: 120h. In some embodiments, the input data set further comprises an indication that that the performance of the wireless links 120;120a: 120h of one of the pairs of the wireless links 120;120a: 120h is impacted by a disturbance event (e.g., wind or another by another disturbance source that causes the antennas to sway).

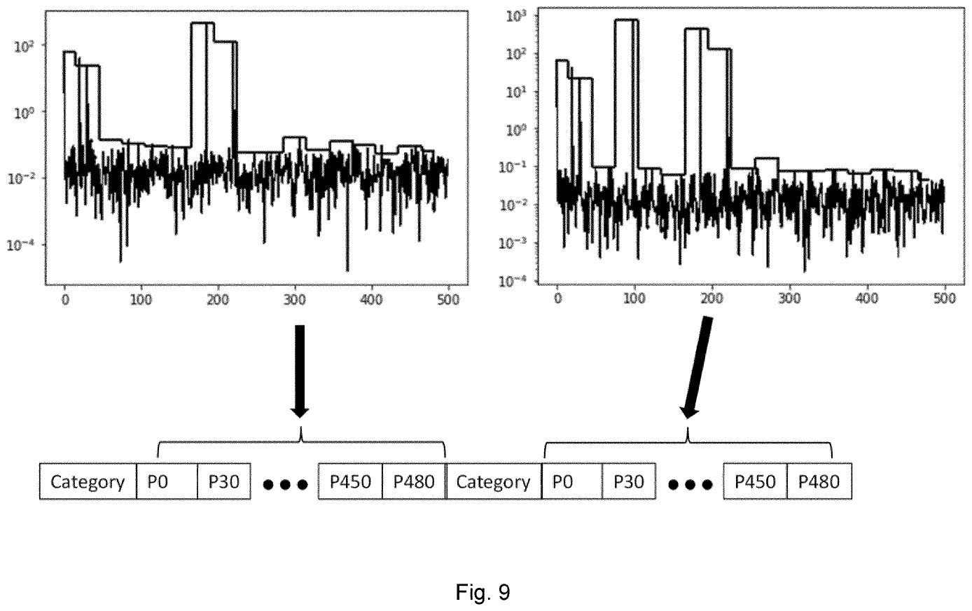

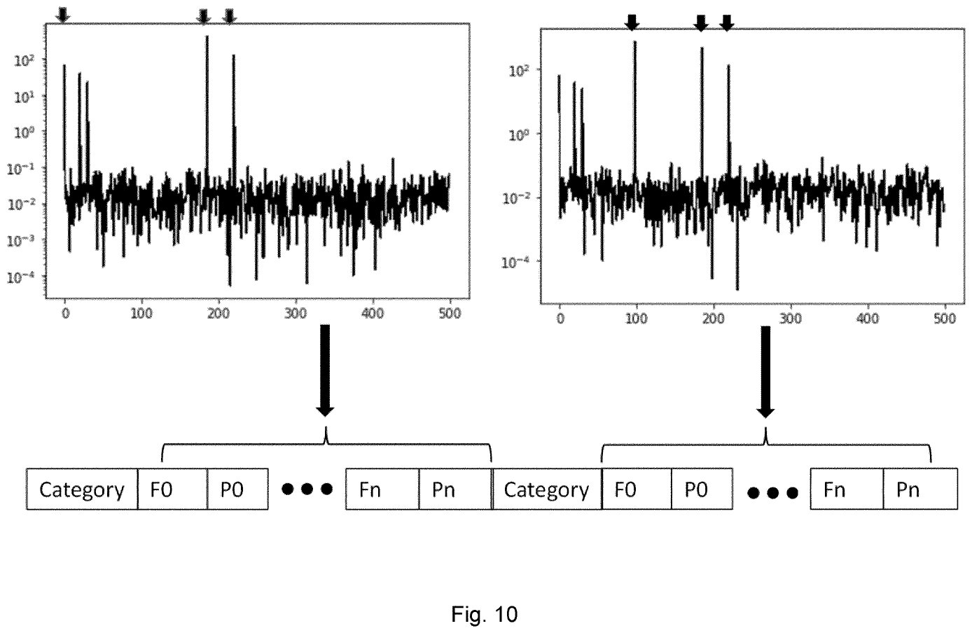

Reference is here made to FIG. 9 and FIG. 10. Both examples show time-series sequences for two wireless links. In FIG. 9 is illustrated an example of an input data set construction using spectrum aggregation over frequency intervals, where each frequency interval is 30 Hz wide. Each frequency interval is represented by the frequency component with highest amplitude in the spectrum. These amplitude values are denoted P0, P30, . . . . P480. That is, for the first frequency interval for the first wireless link, the frequency interval is represented by P0=60.771729, and so on. In FIG. 10 is illustrated an example of an input data set construction using only the n frequency components with highest magnitude, where n=3 in this example.

That is, each time-series sequence is represented only by the three frequency components with highest magnitude in the spectrum. These magnitudes are denoted P0, P1, P2, and the corresponding frequency locations are denoted F0, F1, F2. That is, the first frequency component for the first wireless link is represented by the pair (F0=0.000000, P0=60.267213), and so on, where the first frequency represents the bin of frequencies in the interval from 0 Hz to 30 Hz (excluded).

In some aspects, the supervised machine learning model replaces the decision blocks in FIG. 6 and FIG. 7. The dataset entry that is provided as input to the supervised machine learning model can be described using the Features Vector Method. In some examples, the dataset entry comprises, one categorical value for each wireless link, given by the output of the event classifiers, the site data for each wireless link, the time-series sequences transformed to frequency domain. The output of the supervised machine learning model is the identification of the component at the common end-point 110;110a: 110g that is responsible for causing the disturbance.

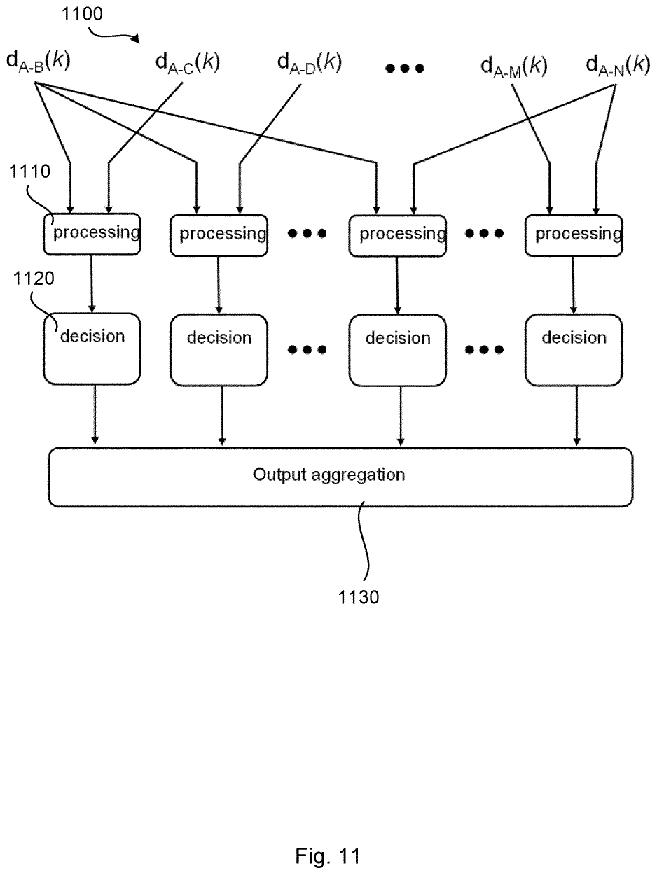

Reference is next made to FIG. 11 which is a block diagram 1100 illustrating how the comparison of time-series sequences from more than two wireless links can be performed. In the figure, the notation dx-y (k) denotes the k:th time-series sequence for the wireless link between end-point X and end-point Y. As illustrated, processing blocks 1110 are provided to compare the time-series sequences from respective pairs of wireless links. Hence, the processing can be performed for all possible pairs of wireless links (with associated site data). The processing blocks can be implemented to perform processing in either the time domain, as in FIG. 6, or in the frequency domain, as in FIG. 7. An output aggregation block 1130 is configured to localize the component causing the disturbance using information provided from decision blocks 1120. Further, the block diagram 1100 can be implemented using the above-described supervised machine learning model.

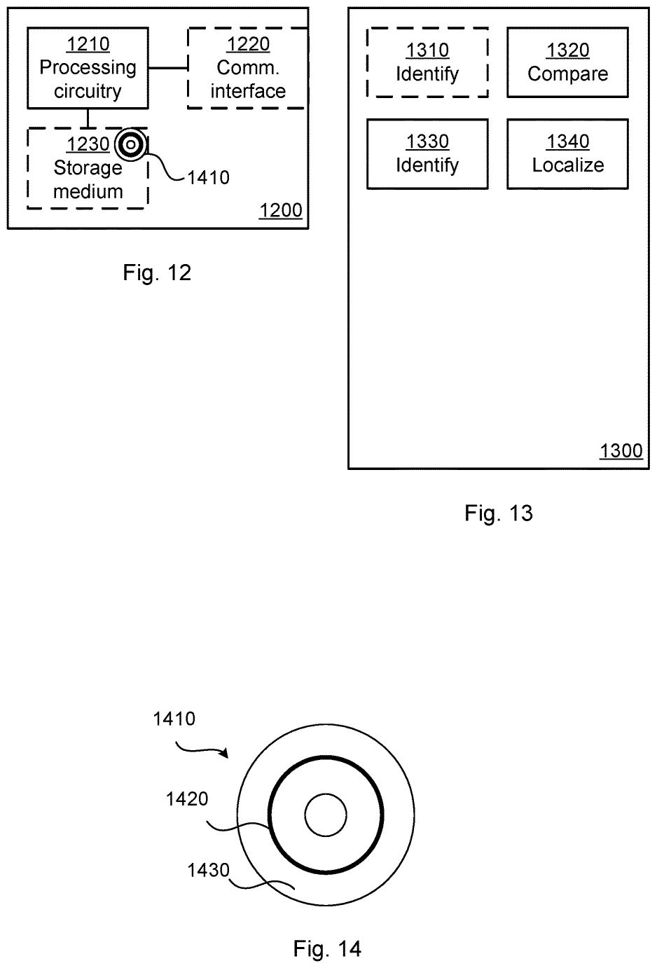

FIG. 12 schematically illustrates, in terms of a number of functional units, the components of a controller entity 1200 according to an embodiment. Processing circuitry 1210 is provided using any combination of one or more of a suitable central processing unit (CPU), multiprocessor, microcontroller, digital signal processor (DSP), etc., capable of executing software instructions stored in a computer program product 1410 (as in FIG. 14), e.g. in the form of a storage medium 1230. The processing circuitry 1210 may further be provided as at least one application specific integrated circuit (ASIC), or field programmable gate array (FPGA).

Particularly, the processing circuitry 1210 is configured to cause the controller entity 1200 to perform a set of operations, or steps, as disclosed above. For example, the storage medium 1230 may store the set of operations, and the processing circuitry 1210 may be configured to retrieve the set of operations from the storage medium 1230 to cause the controller entity 1200 to perform the set of operations. The set of operations may be provided as a set of executable instructions.

Thus the processing circuitry 1210 is thereby arranged to execute methods as herein disclosed. The storage medium 1230 may also comprise persistent storage, which, for example, can be any single one or combination of magnetic memory, optical memory, solid state memory or even remotely mounted memory. The controller entity 1200 may further comprise a communications (comm.) interface 1220 at least configured for communications with other entities, functions, nodes, and devices. As such the communications interface 1220 may comprise one or more transmitters and receivers, comprising analogue and digital components. The processing circuitry 1210 controls the general operation of the controller entity 1200 e.g. by sending data and control signals to the communications interface 1220 and the storage medium 1230, by receiving data and reports from the communications interface 1220, and by retrieving data and instructions from the storage medium 1230. Other components, as well as the related functionality, of the controller entity 1200 are omitted in order not to obscure the concepts presented herein.

FIG. 13 schematically illustrates, in terms of a number of functional modules, the components of a controller entity 1300 according to an embodiment. The controller entity 1300 of FIG. 13 comprises a number of functional modules; a compare module 1320 configured to perform step S104, an identify module 1330 configured to perform step S106, and a localize module 1340 configured to perform step S108. The controller entity 1300 of FIG. 13 may further comprise a number of optional functional modules, such an identify module 1310 configured to perform step S102. In general terms, each functional module 1310:1340 may in one embodiment be implemented only in hardware and in another embodiment with the help of software, i.e., the latter embodiment having computer program instructions stored on the storage medium 1230 which when run on the processing circuitry makes the controller entity 210, 1200, 1300 perform the corresponding steps mentioned above in conjunction with FIG. 13. It should also be mentioned that even though the modules correspond to parts of a computer program, they do not need to be separate modules therein, but the way in which they are implemented in software is dependent on the programming language used. Preferably, one or more or all functional modules 1310:1340 may be implemented by the processing circuitry 1210, possibly in cooperation with the communications interface 1220 and/or the storage medium 1230. The processing circuitry 1210 may thus be configured to from the storage medium 1230 fetch instructions as provided by a functional module 1310:1340 and to execute these instructions, thereby performing any steps as disclosed herein.

The controller entity 210, 1200, 1300 may be provided as a standalone device or as a part of at least one further device. Thus, a first portion of the instructions performed by the controller entity 210, 1200, 1300 may be executed in a first device, and a second portion of the of the instructions performed by the controller entity 210, 1200, 1300 may be executed in a second device; the herein disclosed embodiments are not limited to any particular number of devices on which the instructions performed by the controller entity 210, 1200, 1300 may be executed. Hence, the methods according to the herein disclosed embodiments are suitable to be performed by a controller entity 210, 1200, 1300 residing in a cloud computational environment. Therefore, although a single processing circuitry 1210 is illustrated in FIG. 12 the processing circuitry 1210 may be distributed among a plurality of devices, or nodes. The same applies to the functional modules 1310:1340 of FIG. 13 and the computer program 1420 of FIG. 14.

FIG. 14 shows one example of a computer program product 1410 comprising computer readable storage medium 1430. On this computer readable storage medium 1430, a computer program 1420 can be stored, which computer program 1420 can cause the processing circuitry 1210 and thereto operatively coupled entities and devices, such as the communications interface 1220 and the storage medium 1230, to execute methods according to embodiments described herein. The computer program 1420 and/or computer program product 1410 may thus provide means for performing any steps as herein disclosed.

In the example of FIG. 14, the computer program product 1410 is illustrated as an optical disc, such as a CD (compact disc) or a DVD (digital versatile disc) or a Blu-Ray disc. The computer program product 1410 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1420 is here schematically shown as a track on the depicted optical disk, the computer program 1420 can be stored in any way which is suitable for the computer program product 1410.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A controller entity for localizing disturbance in a network comprising wireless links that extend between pairs of end-points, wherein each of the end-points is composed of components, wherein each of the wireless links is associated with site data defining an abstracted representation of the components per end-point per wireless link, the controller entity comprising processing circuitry, the processing circuitry being configured to cause the controller entity to:
compare time-series sequences for pairs of the wireless links with each other, wherein each of the time-series sequences is composed of link attenuation values for one of the wireless links, and wherein the pairs of wireless links for which the time-series sequences are compared to each other have one of the end-points in common;
identify, based on the compared time-series sequences, that performance of one of the pairs of the wireless links is impaired by a disturbance caused at the end-point that is common for both the wireless links of the one of the pairs of the wireless links; and
localize which component at the common end-point that is responsible for causing the disturbance by comparing the site data of the common end-point for the wireless links of the one of the pairs of the wireless links to each other.

2. The controller entity of claim 1, wherein the wireless links are wireless microwave links, wireless THz links, or free space optical links.

3. The controller entity of claim 1, wherein the site data for each of the end-points is provided as hierarchically-structured labels, extending from a root label to one or more leaf labels, and wherein each of the labels per end-point represents one of the components of the one of the end-points.

4. The controller entity of claim 3, wherein the root label for each of the end-points is defined by a geo-location of the end-point, and wherein the one or more leaf labels per end-point represents one or more of the components of the one of the end-points, such as at least one of a support structure, a mechanical structure, and an antenna of the end-point.

5. The controller entity of claim 1, the processing circuitry further being configured to cause the controller entity, to:
identify, by classifying the time-series sequences, that the performance of the wireless links of the one of the pairs of the wireless links is impacted by a disturbance event.

6. The controller entity of claim 5, wherein a higher sample rate of the time-series sequences is used when comparing the time-series sequences than when classifying the time-series sequences.

7. The controller entity of claim 1, wherein the identifying is based on confirming that the comparison of the time-series sequences for the one of the pairs of the wireless links satisfies a correlation criterion.

8. The controller entity of claim 1, wherein the comparing of the time-series sequences for each pair of wireless links is performed as a time-domain correlation between the time-series sequences for the each pair of wireless links upon the time-series sequences for the each pair of wireless links having been time-synchronized with each other.

9. The controller entity of claim 7, wherein the identifying that the performance of one of the pairs of the wireless links is impaired by the disturbance caused at the end-point that is common for both the wireless links of the one of the pairs of the wireless links is identified comprises verifying that the time-domain correlation satisfies the correlation criterion.

10. The controller entity of claim 1, wherein the comparing of the time-series sequences for each pair of wireless links is performed as a frequency-domain comparison between the time-series sequences for the each pair of wireless links upon the time-series sequences for the each pair of wireless links having been transformed to frequency domain.

11. The controller entity of claim 10, wherein each of the time-series sequences for the each pair of wireless links when having been transformed to the frequency domain is composed of frequency components, and wherein the comparing of the time-series sequences comprises comparing the frequency components of different wireless links of the pair of wireless links with each other.

12. The controller entity of claim 7, wherein the identifying that performance of one of the pairs of the wireless links is impaired by the disturbance caused at the end-point that is common for both the wireless links of the one of the pairs of the wireless links is identified comprises verifying that at least one of the frequency components of different wireless links of the pair of wireless links satisfies the correlation criterion.

13. The controller entity of claim 1, wherein the comparing, the identifying, and the localizing are performed by a supervised machine learning model, wherein the supervised machine learning model is fed an input data set, and wherein the input data set comprises the time-series sequences for each of the wireless links.

14. The controller entity of claim 13, wherein the input data set further comprises an indication that that the performance of the wireless links of the one of the pairs of the wireless links is impacted by a disturbance event.

15. A controller entity for localizing disturbance in a network comprising wireless links that extend between pairs of end-points, wherein each of the end-points is composed of components, wherein each of the wireless links is associated with site data defining an abstracted representation of the components per end-point per wireless link, the controller entity comprising:
a compare module configured to compare time-series sequences for pairs of the wireless links with each other, wherein each of time-series sequences is composed of link attenuation values for one of the wireless links, and wherein the pairs of wireless links for which the time-series sequences are compared to each other have one of the end-points in common;
an identify module configured to identify, based on the compared time-series sequences, that performance of one of the pairs of the wireless links is impaired by a disturbance caused at the end-point that is common for both the wireless links of the one of the pairs of the wireless links; and
a localize module configured to localize which component at the common end-point that is responsible for causing the disturbance by comparing the site data of the common end-point for the wireless links of the one of the pairs of the wireless links to each other.

16. A method for localizing disturbance in a network comprising wireless links that extend between pairs of end-points, wherein each of the end-points is composed of components, wherein each of the wireless links is associated with site data defining an abstracted representation of the components per end-point per wireless link, wherein the method is performed by a controller entity, and wherein the method comprises:
comparing time-series sequences for pairs of the wireless links with each other, wherein each of time-series sequences is composed of link attenuation values for one of the wireless links, and wherein the pairs of wireless links for which the time-series sequences are compared to each other have one of the end-points in common;
identifying, based on the compared time-series sequences, that performance of one of the pairs of the wireless links is impaired by a disturbance caused at the end-point that is common for both the wireless links of the one of the pairs of the wireless links; and
localizing which component at the common end-point that is responsible for causing the disturbance by comparing the site data of the common end-point for the wireless links of the one of the pairs of the wireless links to each other.

17. A computer program for localizing disturbance in a network comprising wireless links that extend between pairs of end-points, wherein each of the end-points is composed of components, wherein each of the wireless links is associated with site data defining an abstracted representation of the components per end-point per wireless link, the computer program comprising computer code which, when run on processing circuitry of a controller entity, causes controller entity to:
compare time-series sequences for pairs of the wireless links with each other, wherein each of time-series sequences is composed of link attenuation values for one of the wireless links, and wherein the pairs of wireless links for which the time-series sequences are compared to each other have one of the end-points in common;
identify, based on the compared time-series sequences, that performance of one of the pairs of the wireless links is impaired by a disturbance caused at the end-point that is common for both the wireless links of the one of the pairs of the wireless links; and
localize which component at the common end-point that is responsible for causing the disturbance by comparing the site data of the common end-point for the wireless links of the one of the pairs of the wireless links to each other.

18. A computer program product comprising the computer program of claim 17, and a computer readable storage medium on which the computer program is stored.
